(19) United States
(12) Patent Application Publication
(10) Pub. No.: US 2007/0258687 A1
(43) Pub. Date: Nov. 8, 2007

(54) Radiation-Curable Resin Composition

(75) Inventors: Keiichi Yamamoto, Tsuchiura (JP); Zen Komiya, Tsukuba (JP)

Correspondence Address: NIXON & VANDERHYE, PC, 901 NORTH GLEBE ROAD, 11TH FLOOR, ARLINGTON, VA, 22203, US

(73) Assignees: DSM IP ASSETS B.V., TE HEERLEN , NETHERLANDS (NL); JSR CORPORATION, TOKYO JAPAN (JP)

(21) Appl. No.: 10/537,993

(22) PCT Filed: Dec. 12, 2003
(86) PCT No.: PCT/NL03/00887

§ 371 Date: Apr. 10, 2006

(30) Foreign Application Priority Data
Dec. 16, 2003 (JP) 2002-363908
Aug. 19, 2003 (JP) 2003-295025

(51) Int. Cl. C08G 18/67; C08K 5/526

(52) U.S. Cl. 385/128; 106/287.21; 106/31.27; 522/169; 522/171

(57) ABSTRACT

A radiation-curable resin composition comprising (A) 0.1-10 wt % of a compound including a phosphite group and a phenolic hydroxyl group was found to have excellent storage stability, produces a cured product which excels in durability and generates only a small amount of hydrogen gas, and is useful for coating optical fiber.

### FIELD OF THE INVENTION

The present invention relates to a radiation-curable resin composition. The invention further relates to the use of the radiation-curable resin composition, a process for the production of a coated optical fiber, a coating composition system, a coated optical fiber, an optical fiber ribbon, an optical fiber cable, and to the use of a compound as a component in a radiation-curable resin composition.

### DESCRIPTION OF RELATED ART

In the manufacture of optical fiber, glass fiber obtained by spinning molten glass is coated with a resin for protection and reinforcement. As the resin coating, a structure in which a flexible primary coating layer is formed on the surface of the optical fiber and a rigid secondary coating layer is formed over the primary coating layer is known. A glass fiber provided with the primary and secondary coating layers is called an optical fiber. An optical fiber ribbon in which optical fibers provided with the resin coating are arranged side by side on a plane and secured using a bundling material is also known. A resin composition for forming the primary coating layers is called a primary material, a resin composition for forming the secondary coating layer is called a secondary material, and a resin composition used as the bundling material for the optical fiber ribbon is called a ribbon matrix material. As the resin coating method, a method of applying a radiation-curable resin composition to an optical fiber and curing the composition by applying heat or light, in particular ultraviolet light, has been widely used.

Hydrogen gas is generated from the coating layer of the optical fiber with the passage of time. The hydrogen gas may cause an optical transmission loss to occur. A coating layer of a conventional radiation-curable resin composition may deteriorate if the optical fiber is allowed to stand at a high temperature for a long period of time, thereby causing the strength of the optical fiber to decrease.

As a method for preventing generation of hydrogen gas from the coating layer of the optical fiber, a method using a raw material including an ethylenically unsaturated group having a specific structure is known from JP-A-9143233. However, since this method limits the choice of raw material for the coating material of the optical fiber, the degrees of freedom relating to the material design are limited.

JP-A-6372740 discloses a method of adding a phosphorus compound such as diphenyl isodecyl phosphite or tris(nonylphenyl) phosphite to the resin composition. However, the radiation-curable resin composition obtained by this method has poor storage stability. Therefore, in the case where the radiation-curable resin composition is stored for a long period of time, the amount of hydrogen gas generated from the cured product of the composition is increased. Moreover, the cured product of the radiation-curable resin composition obtained by the above method has inferior durability, in particular, inferior heat resistance. Therefore, if the cured product is allowed to stand at a high temperature for a long period of time, the weight of the cured product changes.

It is an object of the present invention is to provide a radiation-curable resin composition excelling in storage stability, capable of producing a cured product which excels in durability and generates only a small amount of hydrogen gas, and useful as a coating for optical fiber.

It is a further object of the present invention to provide a coating composition system excelling in storage stability, capable of producing a cured product which excels in durability and generates only a small amount of hydrogen gas, and useful as a coating for optical fiber.

It is a further object of the present invention to use said radiation-curable resin composition as a coating material in a primary coating, a secondary coating, an ink composition or matrix material on an optical glass fiber.

It is a further object of the present invention to provide a process for the production of a coated optical fiber or optical fiber ribbon or optical fiber cable

It is a further object of the present invention to provide a coated optical fiber or an optical fiber ribbon or an optical fiber cable comprising at least one coating obtained by using the radiation-curable resin composition according to the invention.

### DESCRIPTION OF THE INVENTION

It has now surprisingly been found that a radiation-curable resin composition excelling in storage stability and capable of producing a cured product which excels in durability, in particular, heat resistance, and generates only a small amount of hydrogen gas even if the cured product is stored for a long period of time, can be obtained by using a radiation-curable resin comprising (A) a compound which includes a phosphite group and a phenolic hydroxyl group. The radiation-curable resin composition of the present invention is suitable as a coating material for optical fiber, in particular, as a primary coating material, a secondary coating material, a ribbon matrix material or an ink material of an optical fiber coating layer.

The component (A) used in the radiation-curable resin composition of the present invention is not limited insofar as the component (A) is a compound including a phosphite group and a phenolic hydroxyl group. For example, the component (A) can be a compound shown by the following formula (2).
(R¹O)ₙP(OR²)₃₋ₙ (2)
wherein n is an integer of 1-3, R¹ represents an organic group including a phenolic hydroxyl group, and R² represents an organic group which may include a phosphorus atom.

If more than one R¹ and/or R² groups are used, these groups may be the same or different. R¹ and R² may include an element other than carbon. As examples of an element other than carbon, nitrogen, sulfur, oxygen, halogen, and phosphorus can be given. At least two of R¹ and R² may bond to form a cyclic organic group.

As examples of an organic group including a phenolic hydroxyl group represented by R¹, a hydroxyphenyl group, hydroxynaphthyl group, or hydroxyphenylalkyl group in which the benzene ring or naphthalene ring may be replaced by 1-3 alkyl groups, alkoxy groups, or halogen atoms can be given. As examples of an organic group represented by R², an alkyl group, aryl group, aralkyl group, and the like can be given. As examples of an aryl group, a phenyl group or a naphthyl group which may be substituted by one or more substituents chosen from an alkyl group, an alkoxy group, and a halogen atom can be given. As examples of an arylalkyl group, a phenylalkyl group which may be substituted by one or more substituents chosen from an alkyl group, an alkoxy group, and a halogen atom can be given. R¹ may bond to R². As the case where R² includes a phosphorus atom, a case where 2-4 phosphites including a phenolic hydroxyl group bond to a divalent to quadrivalent alkane residue or a divalent to quadrivalent aromatic hydrocarbon residue can be given.

As specific examples of the compound (A) including a phosphite group and a phenolic hydroxyl group, 2-methyl-4-hydroxyphenyldiethyl phosphite, 2-t-butyl-4-hydroxyphenyldiethyl phosphite, 2,5-di-t-butyl-4-hydroxyphenyldiethyl phosphite, bis(2,5-di-t-butyl-4-hydroxyphenyl)ethyl phosphite, tris(2,5-di-t-butyl-4-hydroxyphenyl)phosphite, tetrakis(2,5-di-t-butyl-4-hydroxyphenyl)-2,5-di-t-butyl-hydroxyquinone diyl-phosphite, compounds shown by the following formulas (1), and (3) to (9), and the like can be given.

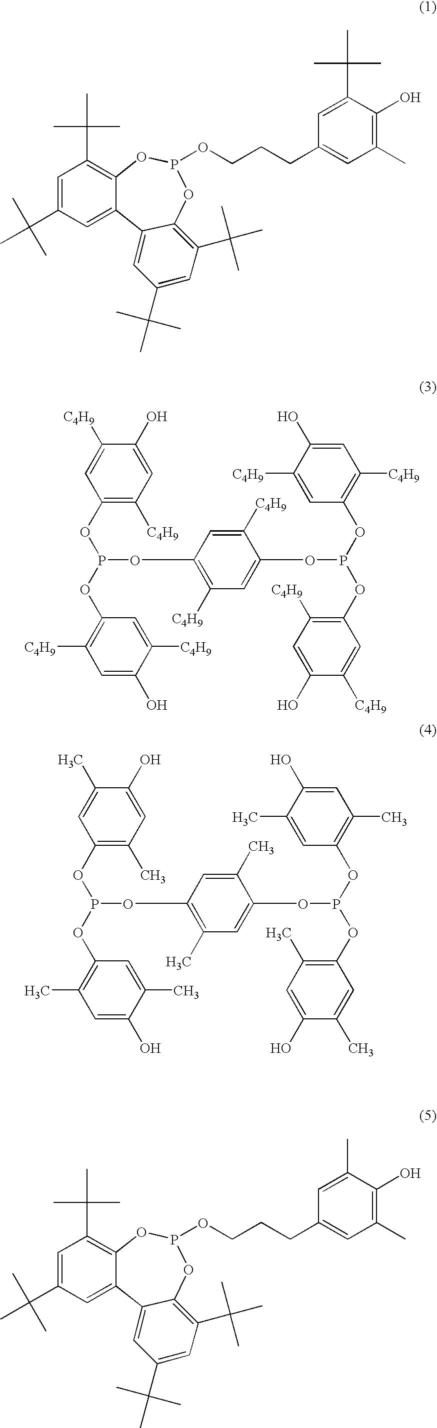

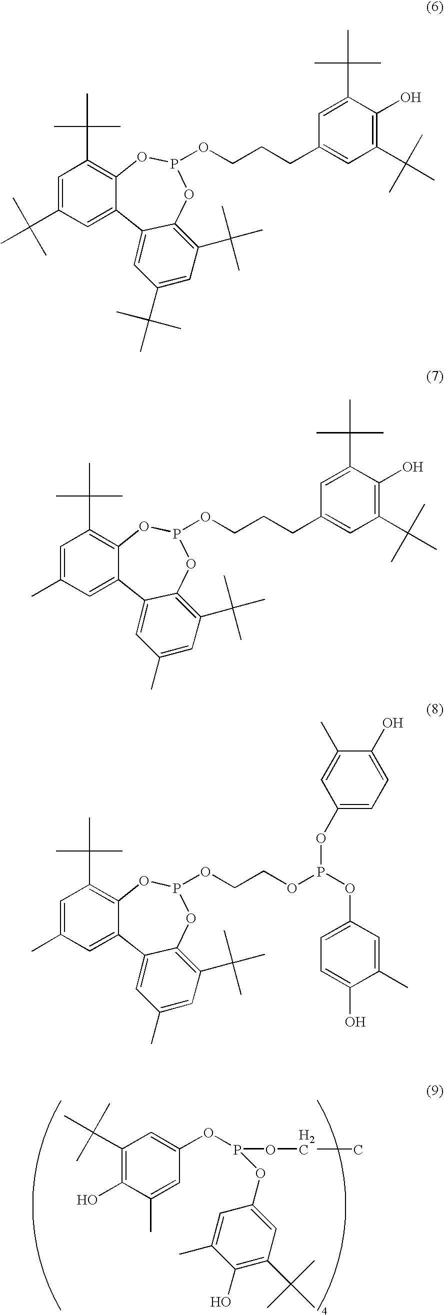

The compound (A) including a phosphite group and a phenolic hydroxyl group may be synthesized by using a method described in “Polymer Degradation and Stability”, 77 (2002), p. 29. As commercially available products of the compound including a phosphite group and a phenolic hydroxyl group, Sumilizer GP (manufactured by Sumitomo Chemical Industries Co., Ltd.) can be given.

As a particularly preferable compound (A) including a phosphite group and a phenolic hydroxyl group, a compound shown by the following formula (1) or (3) can be given.

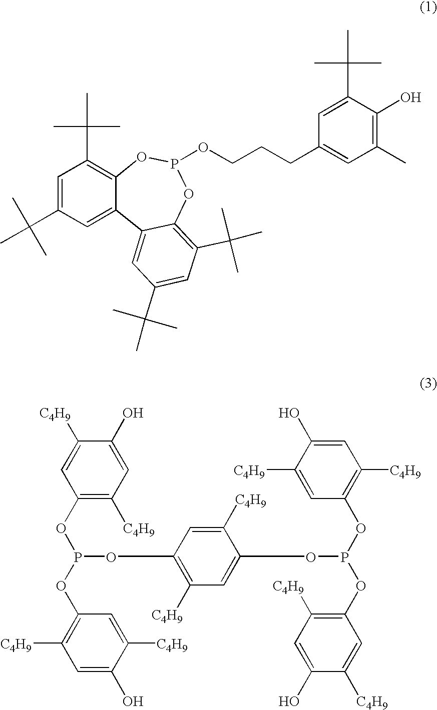

The component (A) is preferably added to the radiation-curable resin composition of the present invention in an amount of 0.1-10 wt % from the viewpoint of stability, durability, and the effect of reducing the amount of hydrogen gas generated. The amount of the component (A) is still more preferably 0.1-5 wt %, and particularly preferably 0.1-3 wt %.

The radiation-curable resin composition of the present invention preferably further comprises (B) a urethane (meth)acrylate, and (C) a reactive diluent copolymerizable with the component (B). There are no specific limitations to the urethane (meth)acrylate (B). For example, the urethane (meth)acrylate (B) is obtained by reacting (a) a polyol compound, (b) a polyisocyanate compound, and (c) a hydroxyl group-containing (meth)acrylate compound.

As specific examples of a method for preparing the urethane (meth)acrylate (B), a method of reacting the polyol (a), polyisocyanate compound (b), and hydroxyl group-containing (meth)acrylate (c) all together; a method of reacting the polyol (a) and the polyisocyanate compound (b), and reacting the resulting product with the hydroxyl group-containing (meth)acrylate (c); a method of reacting the polyisocyanate compound (b) and the hydroxyl group-containing (meth)acrylate (c), and reacting the resulting product with the polyol (a); a method of reacting the polyisocyanate compound (b) and the hydroxyl group-containing (meth)acrylate (c), reacting the resulting product with the polyol (a), and reacting the resulting product with hydroxyl group-containing (meth)acrylate (c); and the like can be given.

As examples of the polyol (a), polyether diols obtained by ring-opening polymerization of one ion-polymerizable cyclic compound such as polyethylene glycol, polypropylene glycol, polytetramethylene glycol, polyhexamethylene glycol, polyheptamethylene glycol, and polydecamethylene glycol, polyether diols obtained by ring-opening copolymerization of two or more ion-polymerizable cyclic compounds, and the like can be given. As examples of ion-polymerizable cyclic compounds, cyclic ethers such as ethylene oxide, propylene oxide, butene-1-oxide, isobutene oxide, oxetane, 3,3-dimethyloxetane, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate can be given. Polyether diols obtained by the ring-opening copolymerization of these ion-polymerizable cyclic compounds with cyclic imines such as ethyleneimine, cyclic lactonic acids such as γ-propyolactone or glycolic acid lactide, or dimethylcyclopolysiloxanes may be used. As specific examples of combinations of two or more ion-polymerizable cyclic compounds, combinations of tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of these ion-polymerizable cyclic compounds may be either a random copolymer or a block copolymer. Of these polyether diols, polypropylene glycol is preferable from the viewpoint of providing jelly resistance and water resistance to the cured product of the present invention. Polypropylene glycol with a polystyrene-reduced number average molecular weight determined by gel permeation chromatography (GPC) of 1000-7000 is particularly preferable.

As examples of commercially available products of these polyether diols, PTMG650, PTMG1000, PTMG2000 (manufactured by Mitsubishi Chemical Corp.), EXCENOL 1020, 2020, 3020, PREMINOL PML-4002, PML-5005 (manufactured by Asahi Glass Co., Ltd.), UNISAFE DC1100, DC1800, DCB1000 (manufactured by Nippon Oil and Fats Co., Ltd.), PPTG1000, PPTG2000, PPTG4000, PTG400, PTG650, PTG1000, PTG2000, PTG-L1000, PTG-L2000 (manufactured by Hodogaya Chemical Co., Ltd.), Z-3001-4, Z-3001-5, PBG2000 (manufactured by Dailchi Kogyo Seiyaku Co., Ltd.), ACCLAIM 2200, 2220, 3201, 3205, 4200, 4220, 8200, 12000 (manufactured by Lyondell), and the like can be given.

The above polyether diols are preferable as the polyol. In addition, polyester diols, polycarbonate diols, polycaprolactone diols, and the like may be used either individually or in combination with the polyether diols. There are no specific limitations to the manner of polymerization of these structural units, which may be any of random polymerization, block polymerization, or graft polymerization.

As examples of the polyisocyanate (b) used for synthesizing the urethane (meth)acrylate (B), aromatic diisocyanates, alicyclic diisocyanates, aliphatic diisocyanates, and the like can be given. There are no specific limitations to the polyisocyanate (B) insofar as the compound can be used in the resin composition for optical fibers. Of these, aromatic diisocyanates and alicyclic diisocyanates are preferable, with 2,4-tolylene diisocyanate and isophorone diisocyanate being still more preferable. These diisocyanate compounds may be used either individually or in combination of two or more.

As the hydroxyl group-containing (meth)acrylate (c) used for synthesizing the urethane (meth)acrylate (B), a hydroxyl group-containing (meth)acrylate in which the hydroxyl group is bonded to the primary carbon atom (hereinafter called “primary hydroxyl group-containing (meth)acrylate”) and a hydroxyl group-containing (meth)acrylate in which the hydroxyl group is bonded to the secondary carbon atom (hereinafter called “secondary hydroxyl group-containing (meth)acrylate”) are preferable in view of reactivity with an isocyanate group of the polyisocyanate.

As examples of the primary hydroxyl group-containing (meth)acrylate, 2-hydroxyethyl(meth)acrylate, 4-hydroxybutyl(meth)acrylate, 1,6-hexanediol mono(meth)acrylate, pentaerythritol tri(meth)acrylate, dipentaerythritol penta(meth)acrylate, neopentyl glycol mono(meth)acrylate, trimethylolpropane di(meth)acrylate, trimethylolethane di(meth)acrylate, and the like can be given.

As examples of the secondary hydroxyl group-containing (meth)acrylate, 2-hydroxypropyl(meth)acrylate, 2-hydroxybutyl(meth)acrylate, 2-hydroxy-3-phenyloxypropyl(meth)acrylate, 4-hydroxycyclohexyl(meth)acrylate, and the like can be given. Further examples include a compound obtained by the addition reaction of (meth)acrylic acid and a glycidyl group-containing compound such as alkyl glycidyl ether, allyl glycidyl ether, or glycidyl(meth)acrylate, and the like. These hydroxyl group-containing (meth)acrylate compounds may be used either individually or in combination of two or more.

The proportion of the polyol (a), polyisocyanate compound (b), and hydroxyl group-containing (meth)acrylate used for synthesizing the urethane (meth)acrylate (B) is preferably determined so that an isocyanate group included in the polyisocyanate compound and a hydroxyl group included in the hydroxyl group-containing (meth)acrylate are respectively 1.1-2 equivalents and 0.1-1 equivalent for one equivalent of a hydroxyl group included in the polyol.

In addition, diamines may be used for synthesizing the urethane (meth)acrylate (B) in combination with a polyol. As examples of diamines, diamines such as ethylenediamine, tetramethylenediamine, hexamethylenediamine, p-phenylenediamine, and 4,4′-diaminodiphenylmethane, diamines containing a hetero atom, polyether diamines, and the like can be given.

Part of the hydroxyl group-containing (meth)acrylate may be replaced by a compound having a functional group which can be added to an isocyanate group or by an alcohol. As examples of a compound having a functional group which can be added to an isocyanate group, γ-aminopropyltriethoxysilane, γ-mercaptopropyltrimethoxysilane, and the like can be given. Use of such a compound can further improve adhesion to substrates such as glass. As examples of an alcohol, methanol, ethanol, isopropyl alcohol, n-butyl alcohol, t-butyl alcohol, and the like can be given. The Young's modulus of the resin can be adjusted by using these compounds.

In the synthesis of the urethane (meth)acrylate (B), it is preferable to use a urethanization catalyst such as copper naphthenate, cobalt naphthenate, zinc naphthenate, dibutyltin dilaurate, triethylamine, 1,4-diazabicyclo[2.2.2]octane, or 2,6,7-trimethyl-1,4-diazabicyclo[2.2.2]octane in an amount of 0.01-1 wt % of the total amount of the reactants. The reaction temperature is usually 5-90° C., and preferably 10-80° C.

The polystyrene-reduced number average molecular weight of the urethane (meth)acrylate (B) determined by GPC is usually 500-40,000, and preferably 700-30,000 in order to ensure good breaking elongation of the cured product and appropriate viscosity of the radiation-curable resin composition of the present invention.

The content of the urethane (meth)acrylate (B) in the radiation-curable resin composition of the present invention is preferably 35-85 wt %, and particularly preferably 55-65 wt % in order to ensure excellent mechanical characteristics such as Young's modulus and breaking elongation of the cured product and appropriate viscosity of the curable resin composition of the present invention. If the content exceeds 85 wt %, since the cured product exhibits a Young's modulus of more than 2.0 MPa, the composition is unsuitable for a resin for coating optical fibers. Moreover, viscosity of the radiation-curable resin composition exceeds 6.0 Pa·s, thereby resulting in decreased workability. Moreover, water resistance of the cured product deteriorates. If the content is less than 35 wt %, breaking strength is decreased. The Young's modulus of the cured product used as a primary layer for optical fibers is preferably 0.1-2.0 MPa. The viscosity of the radiation-curable resin composition is preferably 1.0-6.0 Pa·s.

The component (C) used in the radiation-curable resin composition of the present invention is a reactive diluent copolymerizable with the component (B). As examples of the component (C), (C1) a polymerizable monofunctional compound or (C2) a polymerizable polyfunctional compound can be given. As examples of the polymerizable monofunctional compound (C1), lactams containing a vinyl group such as N-vinylpyrrolidone and N-vinylcaprolactam, (meth)acrylates containing an alicyclic structure such as isobornyl(meth)acrylate, bornyl(meth)acrylate, tricyclodecanyl (meth)acrylate, and dicyclopentanyl(meth)acrylate, benzyl(meth)acrylate, 4-butylcyclohexyl(meth)acrylate, acryloylmorpholine, vinyl imidazole, vinylpyridine, and the like can be given. Further examples include 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl (meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl (meth)acrylate, octyl(meth)acrylate, isooctyl(meth)acrylate, 2-ethylhexyl (meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl (meth)acrylate, isostearyl(meth)acrylate, tetrahydrofurfuryl(meth)acrylate, butoxyethyl (meth)acrylate, ethoxydiethylene glycol (meth)acrylate, benzyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl(meth)acrylate, 7-amino-3,7-dimethyloctyl (meth)acrylate, N,N-diethyl(meth)acrylamide, N,N-dimethylaminopropyl (meth)acrylamide, hydroxybutyl vinyl ether, lauryl vinyl ether, cetyl vinyl ether, 2-ethylhexyl vinyl ether, 2-hydroxy-3-phenoxypropyl acrylate, and a compound shown by the following formula:
CH₂═C(R³)—COO(R⁴O)p-C₆H₄—R⁵
wherein R³ represents a hydrogen atom or a methyl group, R⁴ represents an alkylene group having 2-6, and preferably 2-4 carbon atoms, R⁵ represents a hydrogen atom or an alkyl group having 1-12, and preferably 1-9 carbon atoms, and p is an integer of 0-12, and preferably 1-8.

Of these polymerizable monofunctional compounds (C1), vinyl group-containing lactams such as N-vinylpyrrolidone and N-vinylcaprolactam, monofunctional (meth)acrylate containing an aliphatic hydrocarbon group having 10 or more carbon atoms are preferable. The aliphatic group having 10 or more carbon atoms may be linear, branched, or alicyclic. The number of carbon atoms is preferably 10-24. Of these, isobornyl(meth)acrylate, isodecyl(meth)acrylate, and lauryl(meth)acrylate are still more preferable. Particularly preferable compounds are isobornyl(meth)acrylate and/or isodecyl(meth)acrylate. As examples of commercially available products of these polymerizable monofunctional compounds (C1), IBXA (manufactured by Osaka Organic Chemical Industry Co., Ltd.), Aronix M-110, M-111, M-113, M-114, M-117, and TO-1210 (manufactured by Toagosei Co., Ltd.), and Epoxy Ester M-600A (manufactured by Kyoeisha Chemical Co., Ltd) can be given.

There are no specific limitations to the polymerizable polyfunctional compound (C2) insofar as the compounds can be used in a resin composition for optical fibers. Preferable examples include polyethylene glycol diacrylate, tricyclodecanediyldimethylene di(meth)acrylate, di(meth)acrylate of ethylene oxide addition bisphenol A, tris(2-hydroxyethyl)isocyanurate tri(meth)acrylate, and Hexanediol di acrylate (HDDA). As examples of commercially available products of the polymerizable polyfunctional compound (C2), Light acrylate 9EG-A, 4EG-A (manufactured by Kyoeisha Chemical Co., Ltd.), Yupimer UV, SA1002 (manufactured by Mitsubishi Chemical Corp.), and Aronix M-215, M-315, M-325 (manufactured by Toagosei Co., Ltd.) can be given.

The polymerizable monofunctional compound (C1) and the polymerizable polyfunctional compound (C2) may be used in combination.

The component (C) is added to the radiation-curable resin composition of the present invention in an amount of preferably 1-60 wt %, and particularly preferably 2-45 wt %. If the amount is less than 1 wt %, curability may be impaired. If the amount exceeds 60 wt %, application may become uneven due to low viscosity, thereby resulting in unstable application.

The radiation-curable resin composition of the present invention is cured by application of radiation. Radiation used herein refers to infrared radiation, visible rays, ultraviolet rays, X-rays, α-rays, β-rays, γ-rays, electron beams, and the like. Of these, ultraviolet rays are particularly preferable.

A polymerization initiator (D) may optionally be added to the radiation curable liquid resin composition of the present invention. As the component (D), a photoinitiator (D1) is usually used. If necessary, (D2) a heat polymerization initiator may be used in combination with the photoinitiator (D1).

As examples of the photopolymerization initiator (D1), 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, and the like can be given. As examples of commercially available products of the photopolymerization initiator, Irgacure 184, 369, 651, 500, 907, 819, CGI1700, CGI1750, CGI1850, CGI1870, CG2461, Darocur 1116, 1173 (manufactured by Ciba Specialty Chemicals Co., Ltd.), Lucirin TPO (manufactured by BASF), Ubecryl P36 (manufactured by UCB), and the like can be given.

As examples of heat polymerization initiators (D2), peroxides, azo compounds, and like can be given. Specific examples include benzoyl peroxide, t-butyl oxybenzoate, azobisisobutyronitrile, and the like.

In the case of curing the curable resin composition of the present invention using light, a photosensitizer may be added as required in addition to the photopolymerization initiator. As examples of the photosensitizer, triethylamine, diethylamine, N-methyldiethanoleamine, ethanolamine, 4-dimethyl aminobenzoic acid, methyl 4-dimethylaminobenzoate, ethyl 4-dimethylaminobenzoate, isoamyl 4-dimethylaminobenzoate, and the like can be given. As examples of commercially available products of the photosensitizer, Ubecryl P102, 103, 104, 105 (manufactured by UCB), and the like can be given.

The polymerization initiator (D) is used in the radiation curable liquid resin composition of the present invention in an amount of preferably 0.1-10 wt %, and particularly preferably 0.5-5 wt %.

Additives such as coloring agents, light stabilizers, silane coupling agents, antioxidant, heat polymerization inhibitors, leveling agents, surfactants, preservatives, plasticizers, lubricants, solvents, fillers, aging preventives, wettability improvers, and coating surface improvers may be added to the radiation-curable resin composition in addition to the above components. As examples of light stabilizers, Tinuvin 292, 144, 622LD (manufactured by Ciba Specialty Chemicals Co., Ltd.), Sanol LS770 (manufactured by Sankyo Co., Ltd.), SEESORB 101, SEESORB 103, SEESORB 709 (manufactured by Shipro Kasei Kaisha, Ltd.), Sumisorb 130 (manufactured by Sumitomo Chemical Industries Co., Ltd.), and the like can be given. As examples of silane coupling agents, γ-aminopropyltriethoxysilane, γ-mercaptopropyltrimethoxysilane, γ-methacryloxypropyltrimethoxysilane, commercially available products such as SH6062, SZ6030 (manufactured by Toray-Dow Corning Silicone Co., Ltd.), KBE903, 603, 403 (manufactured by Shin-Etsu Chemical Co., Ltd.), and the like can be given. As examples of antioxidants, Sumilizer GA-80 (manufactured by Sumitomo Chemical Industries Co., Ltd.), Irganox 1010, 1035 (manufactured by Ciba Specialty Chemicals Co., Ltd), and the like can be given.

The invention is also related to a coating composition system comprising a primary coating composition and a secondary coating composition for use as an optical fiber dual coating system, the coating composition system comprising at least one coating composition according to the invention.

The invention as also related to the use of a radiation-curable resin composition according to the invention as a primary coating, a secondary coating, an ink composition or a matrix material on an optical glass fiber, and to a process for the production of coated optical fibers, wherein a radiation-curable resin composition according to the invention is used.

The invention is also directed to a coated optical fiber comprising a glass optical fiber having a primary coating, a coated optical fiber comprising a glass optical fiber having a primary coating and a secondary coating, a coated optical fiber comprising a glass optical fiber having a primary coating, a secondary coating and an upjacketing coating, a coated optical fiber comprising a glass optical fiber and a single coating, a coated optical fiber comprising a glass optical fiber, a single coating and an upjacketing coating, and each coated fiber optionally having an ink composition applied thereon, to an optical fiber ribbon comprising at least two of said coated and optionally inked optical fibers held together by a matrix material, and to an optical fiber cable comprising at least two of said coated and optionally inked optical fibers, wherein at least one of said coatings, ink compositions or matrix materials is derived from a radiation-curable composition according to the invention.

The invention is further directed to the use of (A) a compound including a phosphite group and a phenolic hydroxyl group as a component in a radiation-curable resin composition.

The present invention is described below in more detail by examples. However, the present invention is not limited to these examples.

### EXAMPLES

### Example I

### Synthesis of urethane(meth)acrylate “UA-1”

A reaction vessel equipped with a stirrer was charged with 831.0 g of polypropylene glycol with a number average molecular weight of 2000, 129.3 g of isophorone diisocyanate, 0.24 g of 2,6-di-t-butyl-p-cresol, and 0.08 g of phenothiazine. The mixture was cooled to 15° C. while stirring. After the addition of 0.8 g of dibutyltin dilaurate, the mixture was slowly heated to 35° C. for one hour with stirring. The mixture was heated to 50° C. and allowed to react. When the residual isocyanate concentration decreased to 1.26 wt % or less (percentage with respect to the charged amount, hereinafter the same), 38.6 g of 2-hydroxyethyl acrylate was added. The mixture was allowed to react at about 60° C. with stirring. The reaction was terminated when the residual isocyanate concentration was 0.1 wt % or less to obtain urethane (meth)acrylate (hereinafter referred to as “UA-1”).

### Example II

### Synthesis of urethane(meth)acrylate “UA-2”

A reaction vessel equipped with a stirrer was charged with 907.2 g of polypropylene glycol with a number average molecular weight of 4000, 70.6 g of isophorone diisocyanate, 0.24 g of 2,6-di-t-butyl-p-cresol, and 0.08 g of phenothiazine. The mixture was cooled to 15° C. with stirring. After the addition of 0.8 g of dibutyltin dilaurate, the mixture was slowly heated to 35° C. for one hour with stirring. The mixture was heated to 50° C. and allowed to react. When the residual isocyanate concentration decreased to 0.6 wt % or less (percentage with respect to the charged amount, hereinafter the same), 21.1 g of 2-hydroxyethyl acrylate was added. The mixture was allowed to react at about 60° C. with stirring. The reaction was terminated when the residual isocyanate concentration was 0.1 wt % or less to obtain urethane (meth) acrylate (hereinafter referred to as “UA-2”).

### Example III

### Synthesis of urethane(meth)acrylate “UA-3”

A reaction vessel equipped with a stirrer was charged with 950.9 g of polypropylene glycol with a number average molecular weight of 8000, 37.0 g of isophorone diisocyanate, 0.24 g of 2,6-di-t-butyl-p-cresol, and 0.08 g of phenothiazine. The mixture was cooled to 15° C. with stirring. After the addition of 0.8 g of dibutyltin dilaurate, the mixture was slowly heated to 35° C. for one hour with stirring. The mixture was heated to 50° C. and allowed to react. When the residual isocyanate concentration decreased to 0.4 wt % or less (percentage with respect to the charged amount, hereinafter the same), 11.0 g of 2-hydroxyethyl acrylate was added. The mixture was allowed to react at about 60° C. with stirring. The reaction was terminated when the residual isocyanate concentration was 0.1 wt % or less to obtain urethane (meth) acrylate (hereinafter referred to as “UA-3”).

### Example IV

### Synthesis of urethane(meth)acrylate “UA-4”

A reaction vessel equipped with a stirrer was charged with 96.4 g of isophorone diisocyanate, 0.024 g of 2,6-di-t-butyl-p-cresol, 0.08 g of phenothiazine, and 0.8 g of dibutyltin dilaurate. The mixture was cooled to 15° C. with stirring. 86.9 g of 2-hydroxyethyl acrylate was added using a dripping funnel for one hour. The mixture was slowly heated to 35° C. for one hour with stirring. After the addition of 815.6 g of a copolymer of tetrahydrofuran and 2-methyltetrahydrofuran with a number average molecular weight of 2000 (“PTGL2000” manufactured by Hodogaya Chemical Co., Ltd.), the mixture was allowed to react at 60° C. The reaction was terminated when the residual isocyanate concentration was 0.1 wt % or less to obtain urethane (meth) acrylate (hereinafter referred to as “UA-4”).

### Example V

### Synthesis of urethane(meth)acrylate “UA-5”

A reaction vessel equipped with a stirrer was charged with 845.9 g of polypropylene glycol having a number average molecular weight of 2000, 112.4 g of 2,4-tolylene diisocyanate, 0.24 g of 2,6-di-t-butyl-p-cresol, and 0.08 g of phenothiazine. The mixture was cooled to 15° C. with stirring. After the addition of 0.8 g of dibutyltin dilaurate, the mixture was slowly heated to 35° C. for one hour with stirring. The mixture was heated to 50° C. and allowed to react. When the residual isocyanate concentration decreased to 1.26 wt % or less (percentage with respect to the charged amount, hereinafter the same), 2.5 g of SH 6062 was added dropwise. The mixture was allowed to react at about 60° C. with stirring. After the addition of 33.5 g of 2-hydroxyethyl acrylate, the mixture was allowed to react at about 60° C. with stirring. After the addition of 4.6 g of methanol, the mixture was allowed to react at about 60° C. with stirring. The reaction was terminated when the residual isocyanate concentration was 0.1 wt % or less to obtain urethane (meth)acrylate (hereinafter referred to as “UA-5”).

### Example VI

### Synthesis of urethane(meth)acrylate “UA-6”

A reaction vessel equipped with a stirrer was charged with 854.1 g of polypropylene glycol with a number average molecular weight of 2000, 106.7 g of tolylene diisocyanate, 0.24 g of 2,6-di-t-butyl-p-cresol, and 0.08 g of phenothiazine. The mixture was cooled to 15° C. with stirring. After the addition of 0.8 g of dibutyltin dilaurate, the mixture was slowly heated to 35° C. for one hour with stirring. The mixture was heated to 50° C. and allowed to react. When the residual isocyanate concentration decreased to 1.4 wt % or less (percentage with respect to the charged amount, hereinafter the same), 2.5 g of SH 6062 was added dropwise. The mixture was allowed to react at about 60° C. with stirring. After the addition of 33.5 g of 2-hydroxyethyl acrylate, the mixture was allowed to react at about 60° C. with stirring. After the addition of 2.3 g of methanol, the mixture was allowed to react at 60° C. with stirring. The reaction was terminated when the residual isocyanate concentration was 0.1 w % or less to obtain urethane (meth)acrylate (hereinafter referred to as “UA-6”).

### Example VII

### Synthesis of urethane (meth)acrylate “UA-7”

A reaction vessel equipped with a stirrer was charged with 832.2 g of polypropylene glycol with a number average molecular weight of 2000, 129.5 g of isophorone diisocyanate, 0.24 g of 2,6-di-t-butyl-p-cresol, and 0.08 g of phenothiazine. The mixture was cooled to 15° C. with stirring. After the addition of 0.8 g of dibutyltin dilaurate, the mixture was slowly heated to 35° C. for one hour with stirring. The mixture was heated to 50° C. and allowed to react. After the residual isocyanate concentration was decreased to 1.44 wt % or less (percentage with respect to the charged amount, hereinafter the same), 36.7 g of 2-hydroxybutyl acrylate was added, and the mixture was allowed to react at about 60° C. with stirring. After the addition of 0.5 g of methanol, the mixture was allowed to react at about 60° C. with stirring. The reaction was terminated when the residual isocyanate concentration was 0.1 wt % or less to obtain urethane (meth)acrylate (hereinafter referred to as “UA-7”).

### Examples VII-XVI and Comparative Examples 1-7

### Preparation of Radiation-Curable Resin Compositions

A reaction vessel equipped with a stirrer was charged with compounds according to the composition (weight ratio) shown in Tables 1 and 2. The mixture was stirred at 50° C. until a homogenous solution was obtained to obtain compositions of Examples and Comparative Examples.

### Example XVII

### Synthesis of tetrakis(2,5-di-t-butyl-4-hydroxyphenyl)-2,5-di-t-butyl-hydroxyquinone-diyl-phosphite)

Tetrakis(2,5-di-t-butyl-4-hydroxyphenyl)-2,5-di-t-butyl-hydroxyquinone-diyl-phosphite was synthesized according to the method described in “Polymer Degradation and Stability, 77 (2002), p. 29”.

Method for Measuring the Amount of Hydrogen Gas Generated from Cured Product

A liquid composition was applied to a glass plate using an applicator for a thickness of 381 μm. Ultraviolet rays were applied to the liquid composition at a dose of 0.1 J/cm² in air using a 3.5 kW metal halide lamp (“SMX-3500/F-OS” manufactured by ORC Co., Ltd.) to obtain a cured film with a thickness of about 200 μm. The cured product was allowed to stand at a room temperature of 23° C. and a relative humidity of 50% for 12 hours or more. A glass ampule was filled with 1 g of the cured product and sealed. The glass ampule in which the cured product was placed was aged while heating at 100° C. for seven days. The amount of hydrogen gas in the glass ampule was then measured by gas chromatography.

Tables 1 and 2 show the amount of hydrogen gas generated in the case where the liquid composition was cured immediately after production (initial value), and the amount of hydrogen gas generated in the case where the liquid composition stored at room temperature for one year was cured (after one-year storage).

Method for Measuring the Change in Weight of Cured Film

The liquid composition was applied to a glass plate using an applicator for a thickness of 381 μm. Ultraviolet rays were applied to the liquid composition at a dose of 0.1 J/cm² in air using a 3.5 kW metal halide lamp (“SMX-3500/F-OS” manufactured by ORC Co., Ltd.) to obtain a cured film with a thickness of about 200 μm. The weight of the cured film was measured. The weight of the cured film after aging while heating at 120° C. for one month was also measured. The change in weight was calculated according to the following equation.
Weight change (%)=(weight before aging−weight after aging)/(weight before aging)×100

TABLE 1
Amount of hydrogen gas generated in the case where the liquid composition
was cured immediately after production (initial value), and the amount of
hydrogen gas generated in the case where the liquid composition stored at
room temperature for one year was cured (after one-year storage).

| | | Example | | | | | | | | |
|---|---|---|---|---|---|---|---|---|---|---|
| Component | | VIII | IX | X | XI | XII | XIII | XIV | XV | XVI |
| Component | GP | 0.5 | 1.0 | 0.5 | — | 0.5 | 1.0 | 1.0 | 1.0 | 1.0 |
| (A) | 2P5B | — | — | — | 0.5 | — | — | — | — | — |
| Urethane | UA-1 | 60 | 60 | — | — | — | — | — | — | — |
| acrylate (B) | UA-2 | — | — | 60 | — | — | — | — | — | — |
| | UA-3 | — | — | — | 40 | — | — | — | — | — |
| | UA-4 | — | — | — | — | 80 | — | — | — | — |
| | UA-5 | — | — | — | — | — | 60 | — | — | — |
| | UA-6 | — | — | — | — | — | — | 55 | — | 55 |
| | UA-7 | — | — | — | — | — | — | — | 55 | — |
| Initiator (D) | Lucirin TPO | 1.0 | 0.5 | 5.0 | 1.0 | 1.0 | 1.0 | 1.0 | 1.0 | 1.0 |
| Reactive | M110 | 10 | 10 | 10 | 10 | — | — | 11 | 11 | 11 |
| diluent (C) | M113 | 20 | — | 18.5 | 11 | 18 | 32 | 18.5 | 18.5 | 15 |
| | IBXA | — | 17.5 | — | 30 | — | — | — | — | — |
| | N-Vinylcaprolactam | 7.5 | 10 | 5 | 7.5 | — | 6 | 7.5 | 7.5 | 7.5 |
| | HDDA | — | — | — | — | — | 1 | — | — | — |
| | M600A | — | — | — | — | — | — | — | — | 9.2 |
| | ACMO | — | — | — | — | — | — | 6 | 6 | — |
| Other | DPDP | — | — | — | — | — | — | — | — | — |
| | TNP-O | — | — | — | — | — | — | — | — | — |
| | SZ6030 | — | — | — | — | — | 0.5 | 1.0 | 1.0 | 1.0 |
| | SH6062 | 1.0 | 1.0 | 1.0 | — | — | — | — | — | — |
| | Seesorb 101 | 0.1 | 0.1 | 0.1 | 0.1 | 0.1 | 0.1 | 0.1 | 0.1 | 0.1 |
| | GA-80 | — | — | — | — | 0.5 | 0.6 | 0.6 | 0.6 | 0.6 |
| Amount of | Initial value | 0.5 | 0.5 | 0.6 | 0.5 | 0.5 | 0.5 | 0.5 | 0.5 | 0.5 |
| hydrogen gas | After one-year | 0.5 | 0.5 | 0.6 | 0.5 | 0.5 | 0.5 | 0.5 | 0.5 | 0.5 |
| generated | storage | | | | | | | | | |
| (□l/g) | | | | | | | | | | |

| | | | | | | | | | |
|---|---|---|---|---|---|---|---|---|---|
| Change in weight of cured film (%) | 98 | 99 | 95 | 97 | 98 | 98 | 99 | 98 | 98 |

TABLE 2
Amount of hydrogen gas generated in the case where the liquid composition
was cured immediately after production (initial value), and the amount of
hydrogen gas generated in the case where the liquid composition stored at
room temperature for one year was cured (after one-year storage).

| | | Comparative Example | | | | | | |
|---|---|---|---|---|---|---|---|---|
| Component | | 1 | 2 | 3 | 4 | 5 | 6 | 7 |
| Component | GP | — | — | — | — | — | — | — |
| (A) | 2P5B | — | — | — | — | — | — | — |
| Urethane | UA-1 | 60 | 60 | 60 | — | — | — | — |
| acrylate (B) | UA-2 | — | — | — | — | — | — | — |
| | UA-3 | — | — | — | — | — | — | — |
| | UA-4 | — | — | — | — | — | — | — |
| | UA-5 | — | — | — | 60 | — | — | — |
| | UA-6 | — | — | — | — | 55 | — | 55 |
| | UA-7 | — | — | — | — | — | 55 | — |
| Initiator (D) | Lucirin TPO | 1.0 | 1.0 | 1.0 | 1.0 | 1.0 | 1.0 | 1.0 |
| Reactive | M110 | 10 | 10 | 10 | — | 11 | 11 | 11 |
| diluent (C) | M113 | 20.5 | 19.5 | 20.5 | 32 | 18.5 | 18.5 | 15 |
| | IBXA | — | — | — | — | — | — | — |
| | N-Vinylcaprolactam | 7.5 | 7.5 | 7.5 | 6 | 7.5 | 7.5 | 7.5 |
| | HDDA | — | — | — | 1 | — | — | — |
| | M600A | — | — | — | — | — | — | 9.2 |
| | ACMO | — | — | — | — | 6 | 6 | — |
| Other | DPDP | 1.0 | — | 0.5 | — | — | — | — |
| | TNP-O | — | 1.0 | — | — | — | — | — |
| | SZ6030 | — | — | — | 0.5 | 1.0 | 1.0 | 1.0 |
| | SH6062 | — | 1.0 | — | — | — | — | — |
| | Seesorb 101 | 0.1 | 0.1 | 0.1 | 0.1 | 0.1 | 0.1 | 0.1 |
| | GA-80 | — | — | 0.5 | 0.6 | 0.6 | 0.6 | 0.6 |
| Amount of | Initial value | 0.6 | 0.6 | 0.6 | 2.0 | 2.0 | 2.6 | 2.0 |
| hydrogen gas | After one-year | 2.7 | 2.8 | 3.0 | 3.5 | 3.0 | 4.0 | 3.0 |
| generated | storage | | | | | | | |
| (□l/g) | | | | | | | | |

| | | | | | | | |
|---|---|---|---|---|---|---|---|
| Change in weight of cured film (%) | 68 | 70 | 96 | 95 | 95 | 96 | 92 |

Lucirin TPO: 2,4,6-Trimethylbenzoyldiphenylphosphine oxide (manufactured by BASF)
IBXA: Isobornyl acrylate (manufactured by Osaka Organic Chemical Industry, Ltd.)
M110: Phenyl EO-modified acrylate (manufactured by Toagosei Co., Ltd.)
M113: Nonylphenyl EO-modified acrylate (manufactured by Toagosei Co., Ltd.)
SH6062: γ-Mercaptotrimethoxysilane (manufactured by Toray-Dow Corning Silicone
Co., Ltd.)
2P5B: Tetrakis(2,5-di-t-butyl-4-hydroxyphenyl)-2,5-di-t-butyl-
hydroxyquinone-diyl-phosphite)
GP: Sumilizer GP (manufactured by Sumitomo Chemical Industries Co., Ltd.)
GA-80: Sumilizer GA-80 (manufactured by Sumitomo Chemical Industries Co., Ltd.)
DPDP: Diphenylisodecyl phosphite (manufactured by Sanko Co., Ltd.)
TNP-O: Tris(nonylphenyl)phosphite (manufactured by Sanko Co., Ltd.)
HDDA: Hexanediol diacrylate
M600A: 2-Hydroxy-3-phenoxypropyl acrylate
ACMO: Acryloyl morpholine
SZ6030: γ-Methacryloxypropyltrimethoxysilane

As is clear from Tables 1 and 2, the radiation-curable resin composition of the present invention has excellent storage stability and produces a cured product which excels in durability, in particular, heat resistance, and generates only a small amount of hydrogen gas.

1. A radiation-curable resin composition comprising
(A) a compound including a phosphite group and a phenolic hydroxyl group.

2. The radiation-curable resin composition according to claim 1, wherein compound (A) is chosen from the compounds with formula (1) and formula (3):

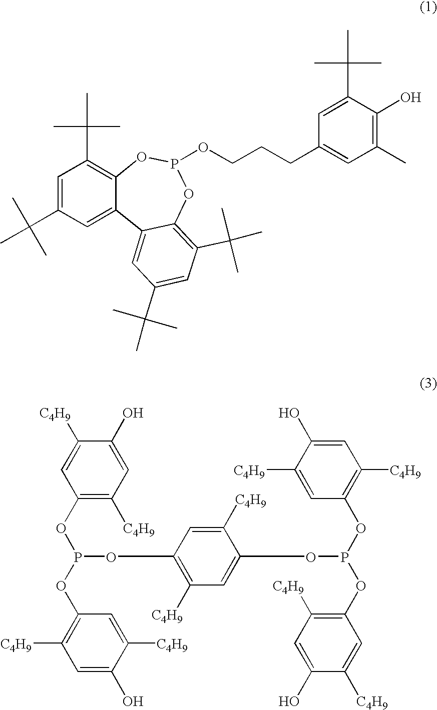

3. The radiation-curable resin composition according to claim 1, wherein 0.1-10 wt % of compound (A) is present.

4. The radiation-curable resin composition according to claim 1, further comprising (B) a urethane (meth)acrylate, and (C) a reactive diluent copolymerizable with the component (B).

5. The radiation-curable resin composition according to claim 4, comprising
(A) 0.1-10 wt % of a compound including a phosphite group and a phenolic hydroxyl group,
(B) 35-85 wt % of a urethane (meth)acrylate, and
(C) 1-60 wt % of a reactive diluent copolymerizable with the component (B).

6. A coating composition system, said system comprising a primary coating composition and a secondary coating composition for use as an optical fiber dual coating system, wherein at least one of the coating compositions is a composition according to claim 1.

7. Use of a radiation-curable resin composition according to claim 1 as a primary coating, a secondary coating, an ink composition or a matrix material on an optical glass fiber.

8. Process for the production of coated optical fibers, wherein a radiation-curable resin composition according to claim 1 is used.

9. A coated optical fiber comprising a glass optical fiber having a primary coating, a coated optical fiber comprising a glass optical fiber having a primary coating and a secondary coating, a coated optical fiber comprising a glass optical fiber having a primary coating, a secondary coating and an upjacketing coating, a coated optical fiber comprising a glass optical fiber and a single coating, a coated optical fiber comprising a glass optical fiber, a single coating and an upjacketing coating, and each coated fiber optionally having an ink composition applied thereon, an optical fiber ribbon comprising at least two of said coated and optionally inked optical fibers held together by a matrix material, or an optical fiber cable comprising at least two of said coated and optionally inked optical fibers, wherein at least one of said coatings, ink compositions or matrix materials is derived from a radiation-curable composition according to claim 1.

10. Use of (A) a compound including a phosphite group and a phenolic hydroxyl group as a component in a radiation-curable resin composition.
